(19) United States
(12) Patent Application Publication
(10) Pub. No.: US 2005/0223383 A1
(43) Pub. Date: Oct. 6, 2005

(54) Methods and apparatus for reserving an execution thread

(76) Inventor: Raymond Scott Tetrick, Portland, OR (US)

Correspondence Address: MARSHALL, GERSTEIN & BORUN LLP, 233 S. WACKER DRIVE, SUITE 6300, SEARS TOWER, CHICAGO, IL, 60606, US

(21) Appl. No.: 10/813,794

(22) Filed: Mar. 31, 2004

(51) Int. Cl. G06F 9/46

(52) U.S. Cl. 718/104

(57) ABSTRACT

Methods and apparatuses for reserving an execution thread are disclosed. A selected processing unit is described as a peripheral device in a device description. Peripheral devices are prevented from using the selected processing unit. A processor description includes one or more available processing units, and omits the selected processing unit. The processor description is provided to an operating system. The device description of the selected processing unit may be read and recognized as a device description of a peripheral device. A device driver may be retrieved for the processing units based on the device description of the processing unit, and resources may be allocated to the processing unit based on a request from the driver.

### FIELD OF THE TECHNOLOGY

The application relates generally to multithreading, and, more particularly, to reserving one or more execution threads for system level uses.

### BACKGROUND

With the introduction of multithreading-capable processors and multicore processors, computer systems may include an abundance of execution threads. For example, a multicore processor having four processing cores may generally permit at least four simultaneous execution threads. Logical processing units, such as those available with multithreading-capable processors, may outnumber the processing cores, thereby permitting even more execution threads. Some of these execution threads may be used for system level resources and capabilities, but are generally utilized solely by the operating system. Conventional computer systems generally require intelligence external to the processors to perform system level functions, such as peripheral I/O devices. Bus configuration space may be used to identify a peripheral device to cause resources to be allocated for that device. However, this does not include a processing core of the computer system, and hence does not permit execution threads to be used for system level uses.

Generally, when the basic input/output system (BIOS), or other startup program, is activated for a computer system, the BIOS searches for available processing units. The BIOS loads an operating system and informs the operating system that the processing units are available for its use. The operating system will use as many threads as are available for performing tasks and applications, thereby using all available execution threads prior to an execution thread being made available for a system level use. For example, if the operating system is informed of four available processing units, the operating system generally utilizes all four processing units and corresponding execution threads. However, in order for system level resources to use an execution thread, the execution thread or a processing unit should be reserved. In other words, system level resources are prevented from using available execution threads because the operating system tends to utilize all available execution threads.

Potential applications for system level use of execution threads include service processors for server systems, isochronous operations (e.g., real time needs), system devices and performance enhancing threads. Service processors may continuously monitor the health of the server system with full access to the operating system (OS) and server system structures. Isochronous operations may include a process that runs an OS kernel external to the operation of the general OS to serve a unique time-critical processing need. System devices may use a thread to provide a custom device driver with full access to system caches and paging structures. Performance enhancing threads may be used to pre-fetch information to system caches and processor structures to speed executions, or other performance feature improvements. For example, helper threads may use additional execution threads to increase single threaded machine performance. An execution thread may be used to partition a network stack on a processor, making it unavailable to the operating system and resulting in higher network performance with lower overall processor utilization by the OS. This frees resources for other tasks. In addition, an execution thread may be used as a private processor for server management.

### BRIEF DESCRIPTION OF THE DRAWINGS

FIG. 1 is a flowchart of an example of a startup routine for reserving an execution thread for a system level use; and

FIG. 2 is a flowchart of an example of an effect the routine of FIG. 1 may have on an operating system routine.

### DETAILED DESCRIPTION OF THE EXAMPLES

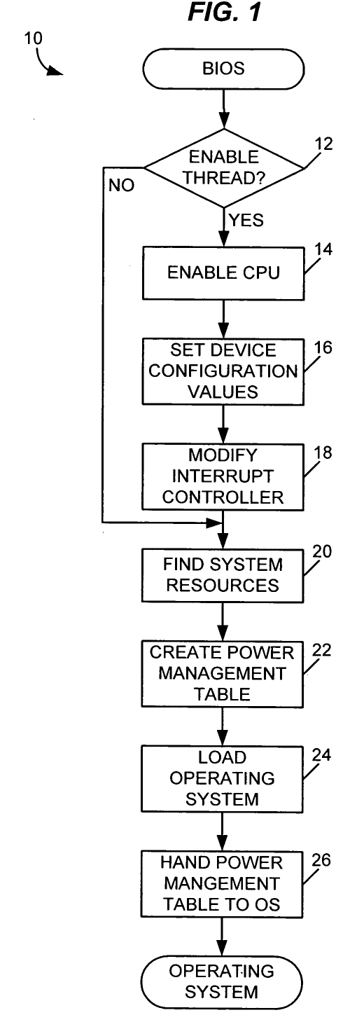

An example of a startup routine 10 is shown generally in FIG. 1. Although the startup routine 10 is particularly well suited for computing devices having multicore processors and a peripheral component interconnect (PCI) bus, or the like, the teachings of the instant application are not limited to any particular type of computer device, processor or bus. On the contrary, the teachings of the application can be employed with virtually any computer device capable of multithreading. Thus, although the startup routine 10 will be described below primarily in relation to a computer device having a multicore processor and PCI bus, the apparatus and method could likewise be used with any type of computer device, processor, bus, etc. In addition, although described primarily as reserving a single processing unit, the startup routine 10 may be utilized to reserve multiple processing units.

To prevent an operating system from utilizing all available processing units, and hence execution threads, the startup routine 10 is generally implemented prior to informing the operating system of the available processing units. Therefore, the startup routine 10 shown in FIG. 1 may be part of the basic input/output system (BIOS) program initiated during the startup of a computing device, though other startup programs executed prior to providing an operating system with available processing units may likewise be modified. Although the following discussion discloses a processing unit, a processing unit may refer to either a logical processing unit or a processing core which may include one or more logical processing units. Generally, a logical processing unit may relate to a single execution thread. Likewise, a processing core may relate to one or more execution threads. Reservation of a processing unit thereby results in the reservation of one or more execution threads.

The startup routine 10 begins at block 12 where the startup routine 10 determines whether or not an execution thread or processing unit will be reserved for system level use. This may be implemented as a manual setup option made available during system startup, or as an automatic default setting made by a modification to the CMOS setup. The determination at block 12 may specifically refer to whether or not a virtual device will be enabled. As used herein, a virtual device is one or more execution threads reserved for system tasks that communicates with the operating system as a device. The virtual device would include much of the description of a physical peripheral device, implemented as a thread of execution of dedicated code, but would not actually include the physical peripheral device. Instead, the virtual device would exist only in memory. Enabling the virtual device would cause further actions to be taken to create a description of the virtual device and reserving a processing unit for system level use.

If it is determined at block 12 that the virtual device is not to be enabled, the BIOS may continue its sequence as normal, such as finding and listing system resources (e.g., processing cores), loading real-time executives, loading the operating system, informing the operating system of available processing units, enabling peripheral device BIOS, executing expansion BIOS or any other additional startup processes normally executed by the BIOS. If the virtual device is not enabled at block 12, the startup routine 10 will inform the operating system of all available processing units, and the operating system will proceed to use all the processing units.

If the virtual device is enabled at block 12, an enable signal may be provided to the system processor (e.g., central processing unit) at block 14 to enable the system processor to accept a new device description. The enable signal may simply be in the form of a command bit provided to the system processor. Once enabled, the system processor exposes the bus configuration space which describes known peripheral devices to the BIOS. In other words, the system processor write-enables the bus configuration space, so that a description of the virtual device may be written.

At block 16, the startup routine 10 sets device configuration values for the virtual device by writing a PCI configuration header. The device configuration is generally written to describe the reserved processing unit(s) as a device and is implemented as base address registers accessible by both a front side bus and by the system processor. The configuration header is accessible via the front side bus to allow access from the operating system and BIOS, and via the system processor to allow access from the processing unit, thereby allowing communication between the operating system and the processing unit. Multiple configuration headers may be written according to the number of execution threads to be reserved and/or according to the number of different uses for the execution threads. In essence, the reserved processing unit is being described as a device to cause the operating system to allocate resources for the processing unit. Once the configuration header has been written, the processing unit may be notified of the change in the configuration space using interrupts.

The various configuration values used to describe the virtual device (i.e., the processing unit) may include: Device ID, Vendor ID, allocated address space, interrupt capabilities, BIOS code address to be executed prior to boot and power saving capabilities. Additional values may likewise be written to describe the virtual device. Although the configuration value may be set to default or dummy values, the configuration values are generally set according to the intended use of the processing unit. For example, the Vendor ID and Device ID are generally set according to the manufacturer's identification (i.e., Vendor ID) and a description of the device as defined by the manufacturer (i.e., Device ID) so that the appropriate driver may be retrieved and loaded. The remaining configuration values are generally set to indicate the resources to be used by the processing unit, behavior and abilities for the processing unit. Although described as a PCI bus configuration header with corresponding values used for PCI bus devices, other device descriptions may likewise be written, the structure and content of which may depend on the particular bus system being utilized or the manner in which a peripheral device is described to the operating system.

In addition to creating a device configuration header at block 16, the startup routine 10 may reconfigure an interrupt controller, such as an advanced programmable interrupt controller, at block 18 to disconnect or otherwise prevent any interrupts from being directed to the reserved processing unit. Other peripheral devices are thereby prevented from attempting to utilize the reserved processing unit for the servicing of interrupts.

Following the creation of the bus configuration header and the modification of the interrupt controller (APIC), the startup routine 10 may continue with the standard startup procedure (e.g., a standard BIOS procedure). Included in the procedure would be the discovery of the resources of the computer system at block 20, which would include the discovery of the processing units of the system processor. In addition, the BIOS scans the bus for peripheral devices to find system resources. The virtual device may be found in a similar manner by the startup routine 10.

At block 22, the startup routine 10 creates a power management table, such as an advanced configuration and power interface (ACPI) table, to inform the operating system of the system processor. Alternatively, the power management table may be pre-made and modified, as opposed to re-creating the power management table during each startup. Included in the power management table is a description of the system processor describing the available processing units discovered from block 20. If the virtual device was not enabled at block 12, the startup routine 10 would include all functioning processing units in the power management table. However, if the virtual device was enabled at block 12, the startup routine excludes the reserved processing unit from the power management table. The reserved processing unit may also be omitted from the table if the startup routine 10 is designed to refuse to recognize the processing unit at block 20. Although a power management table is disclosed as a method of informing the operating system of available processing units, additional methods of informing the operating system of available processing units may likewise be modified to omit the reserved processing unit.

At block 24, the startup routine 10 loads the operating system of the computer system into memory. In addition, any expansion BIOS on peripheral devices may be executed, which may include an expansion BIOS, or other startup program, for the virtual device, if provided. Once the operating system is loaded, the startup routine 10 provides the operating system with the available processing units via the power management table at block 26. If the reserved processing unit is omitted, the operating system will not recognize that it actually exists, and will proceed to use only the processing units that the operating system knows of for general tasks. Control may then be transferred to the operating system.

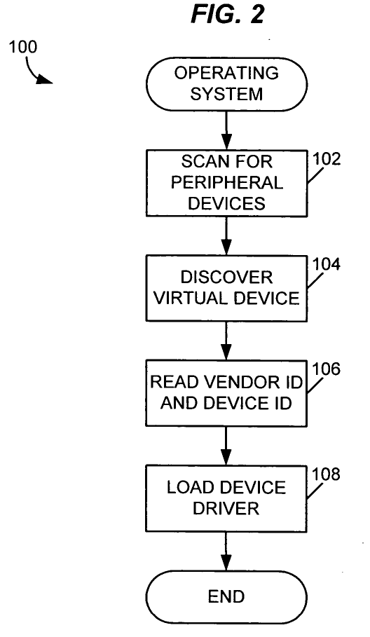

FIG. 2 is a flowchart depicting the behavior of an operating system routine 100 in relation to the virtual device created during the startup routine 10 of FIG. 1. Referring to FIG. 2, the operating system routine 100 performs its standard operations beginning at block 102, where the operating system scans for peripheral devices. The operating system scans for peripheral devices by searching the configuration space for configuration headers describing the various peripheral devices. Among the device configuration headers discovered by the operating system at block 104 is the virtual device configuration header created by the startup routine 10.

As with any configuration header, the operating system routine 100 reads the Vendor ID and Device ID at block 108 to retrieve the appropriate driver. As mentioned above, a driver may be created to facilitate the operation of the processing unit for a particular system level use. The operating system 100 then loads the driver at block 108 so the processing unit can communicate with the operating system and vice versa. The driver requests the operating system to allocate resources (e.g., a block of memory) to the processing unit. In return, the operating system informs the driver of the location of the resource (e.g., the location of the memory block), thereby allowing the processing unit to use the resource. Resources may also be allocated in accordance with the configuration values written to the configuration header.

Using the above system and method, the operating system is prevented from using a processing unit, as would usually be the case. Instead, the operating system recognizes the processing unit as a peripheral device, and communicates with the processing unit accordingly. This includes reading a description of the processing unit as if it were a device, loading an appropriate driver designed according to the use of the processing unit, and communicating with the processing unit as if it were a device using the driver.

Various methods and apparatus have been described herein, which may be implemented as hardware, software or firmware. The methods and apparatus may further be implemented in one or more routines, which may reside on a machine-accessible medium. A machine-accessible medium may include any mechanism that provides (i.e., stores and/or transmits) information in a form accessible by a machine (e.g., a computer, network device, personal digital assistant, manufacturing tool, any device with a set of one or more processors, etc.). For example, a machine-accessible medium includes recordable/non-recordable media (e.g., read only memory (ROM); random access memory (RAM); magnetic disk storage media; optical storage media; flash memory devices; etc.), as well as electrical, optical, acoustical or other form of propagated signals (e.g., carrier waves, infrared signals, digital signals, etc.); etc.

Although certain apparatus constructed in accordance with the teachings of the invention have been described herein, the scope of coverage of this patent is not limited thereto. On the contrary, this patent covers all embodiments of the teachings of the invention fairly falling within the scope of the appended claims either literally or under the doctrine of equivalents.

1. A method of reserving an execution thread comprising:
describing a selected processing unit as a peripheral device in a device description;
preventing peripheral devices from using the selected processing unit; and
providing a processor description including one or more available processing units to an operating system, wherein the selected processing unit is omitted from the processor description.

2. The method of claim 1 further comprising:
reading the device description of the selected processing unit;
recognizing the device description of the processing unit as a device description of a peripheral device;
retrieving a device driver for the processing unit based on the device description of the selected processing unit; and
allocating resources to the selected processing unit based on a request from the driver.

3. The method of claim 2 further comprising communicating with the processing unit as a peripheral device via the driver.

4. The method of claim 1, wherein the device description comprises an identification unique to the selected processing unit.

5. The method of claim 1, wherein the device description comprises at least one of the following: vendor identification, device identification, allocated address space, interrupt capabilities, basic input/output system code address and power saving capabilities.

6. The method of claim 1, wherein describing the selected processing unit comprises describing the selected processing unit as a peripheral device in a bus configuration header.

7. The method of claim 1, wherein describing the selected processing unit comprises creating the device description and setting device configuration values for the selected processing unit.

8. The method of claim 1, wherein describing the selected processing unit comprises describing the selected processing unit as a peripheral device in a device configuration description within a bus configuration space.

9. The method of claim 1, wherein preventing peripheral devices from using the selected processing unit comprises modifying an interrupt controller to prevent the selected processing unit from receiving interrupt requests.

10. The method of claim 1, wherein providing the processor description of one or more available processing units to an operating system comprises providing a power management table to the operating system, wherein the power management table includes a description of all available processing units except the selected processing unit.

11. The method of claim 1 further comprising enabling a processor to allow the device description to be written and notifying the selected processing unit of the device description.

12. The method of claim 1 further comprising accessing the selected processing unit from a front side bus and from a processor.

13. The method of claim 1 further comprising executing at least one of the following using the selected processing unit: a system health monitor, an operating system kernel external to the operating system, a device, a system performance enhancement, a network stack partition, and server management.

14. The method of claim 1, wherein the processing unit comprises a logical processing unit related to one or more execution threads.

15. The method of claim 1, wherein the processing unit comprises a processing core related to one or more execution threads.

16. A basic input/output system program performing the method of claim 1.

17. A method of reserving an execution thread comprising:
searching for device descriptions of peripheral devices;
reading a device description relating to a processing unit, the device description comprising an identification relating to the processing unit;
recognizing the device description of the processing unit as a device description of a peripheral device;
retrieving a driver for the processing unit based on the identification; and
allocating resources to the processing unit based on a request from the driver.

18. The method of claim 17 further comprising communicating with the processing unit as a peripheral device via the driver.

19. The method of claim 17 wherein searching for device descriptions comprises reading bus configuration headers and reading the device description relating to the processing unit comprises reading a bus configuration header written for the processing unit.

20. The method of claim 17, further comprising reading a description of a processor including one or more available processing units, wherein the processing unit is omitted from the processor description.

21. An operating system performing the method of claim 17.

22. An article of manufacture comprising:
a computer readable memory;
a routine stored on the computer readable memory and adapted to be executed on a processor to describe a selected processing unit as a peripheral device in a device description;
a routine stored on the computer readable memory and adapted to be executed on a processor to prevent peripheral devices from using the selected processing unit; and
a routine stored on the computer readable memory and adapted to be executed on a processor to provide a processor description including one or more available processing units to an operating system, wherein the selected processing unit is omitted from the processor description.

23. The article of manufacture of claim 22 wherein the routine to describe a selected processing unit as a peripheral device in a device description comprises a routine stored on the computer readable memory and adapted to be executed on a processor to describe the selected processing unit as a peripheral device in a bus configuration header.

24. The article of manufacture of claim 22, wherein the routine to describe a selected processing unit as a peripheral device in a device description comprises a routine stored on the computer readable memory and adapted to be executed on a processor to create the device description and set device configuration values for the selected processing unit.

25. The article of manufacture of claim 22, wherein the routine to prevent peripheral devices from using the selected processing unit comprises a routine stored on the computer readable memory and adapted to be executed on a processor to modify an interrupt controller to prevent the selected processing unit from receiving interrupt requests.

26. The article of manufacture of claim 22, wherein the routine to provide the processor description comprises a routine stored on the computer readable memory and adapted to be executed on a processor to provide a power management table to the operating system, wherein the power management table include a description of all available processing unit except the selected processing unit.
